(19) United States
(12) Patent Application Publication
(10) Pub. No.: US 2004/0098341 A1
(43) Pub. Date: May 20, 2004

(54) Method for renting video and audio media through the internet

(76) Inventors: Alex Urich, Rancho Santa Margarita, CA (US); Harry Kosalos, Laguna Hills, CA (US)

Correspondence Address: IRELL & MANELLA LLP, 840 NEWPORT CENTER DRIVE, SUITE 400, NEWPORT BEACH, CA, 92660, US

(21) Appl. No.: 10/300,198

(22) Filed: Nov. 19, 2002

(51) Int. Cl. H04K 1/00

(52) U.S. Cl. 705/51

(57) ABSTRACT

A method and system for downloading and playing a file that is transmitted through a network. The file may include a media file that contains video and/or audio data. The file is downloaded from a server to a computer. In addition to the video and/or audio data, the file also contains a play time and an authorized number of copies. When a user attempts to play the file, the computer contains a program that only plays the file if the play time and authorized number of copies has not been exceed.

### BACKGROUND OF THE INVENTION

1. Field of the Invention

The subject matter disclosed generally relates to a method and system for playing a file, such as an audio or video file, that is transmitted through a network.

2. Background Information

There have been developed software programs that allow a computer user to download and play an audio file or a video file. The files are stored on a server which contains a graphical user interface that allows a user to access one or more files. The files are typically downloaded from the server to a user's computer. Unfortunately, once stored in the user's computer the provider typically has no means of restricting use of the file. It has been found that user's will freely exchange files without compensation to the provider. It would be desirable to provide a system that allows the provider of media files to control the playing of the files.

### BRIEF SUMMARY OF THE INVENTION

A method and system for playing a file that is transmitted through a network. The file contains a play time. A computer program determines whether the play time is exceeded and plays the file if the play time is not exceeded.

### BRIEF DESCRIPTION OF THE DRAWINGS

FIG. 1 is a schematic of a system that can download and play a file;

FIG. 2 is a schematic of a computer of the system;

FIGS. 3a-3b are a flowchart showing the downloading and playing of a file transmitted through the network.

### DETAILED DESCRIPTION

Disclosed is a method and system for downloading and playing a file that is transmitted through a network. The file may include a media file that contains video and/or audio data. The file is downloaded from a server to a computer. In addition to the video and/or audio data, the file also contains a play time and an authorized number of copies. When a user attempts to play the file, the computer contains a program that only plays the file if the play time and authorized number of copies has not been exceed.

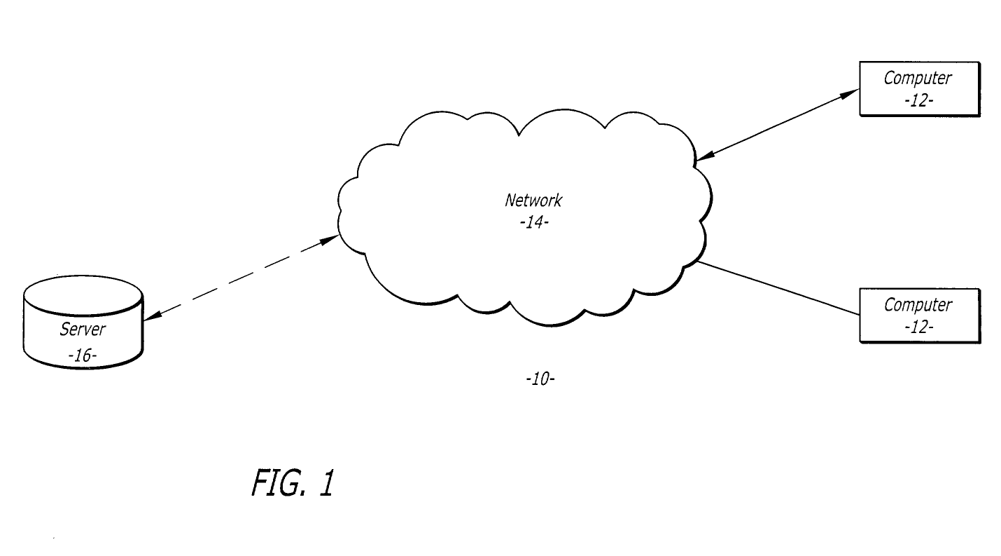

Referring to the drawings more particularly by reference numbers, FIG. 1 shows a system 10 that can be used to download and play a media file. The system 10 includes one or more computers 12 that are connected to an electronic communication network 14. The electronic communication network 14 may be a wide area network (WAN) such as the Internet. Accordingly, communication may be transmitted through the network 14 in TCP/IP format. Although a WAN is described, it is to be understood that the network 14 may be a metropolitan area network (MAN), or a local area network (LAN). Additionally, although the Internet is described, it is to be understood that the network 14 may be a WAN system that operates in a protocol other than TCP/IP.

The system 10 also includes a server 16 that is connected to the network 14. The server 16 may contain one or more files and hardware/software that allows a user to download the files to the computers 12 through the network 14. The files may be stored in one or more databases. Each file may include a media file, a play time field and an authorized number of copies field. The media file may contain video and/or audio data. By way of example, the video data may be a movie picture., the audio data may be a song. The play time field contains the authorized play time purchased by the user. The copies field contains the number of copies purchased by the user.

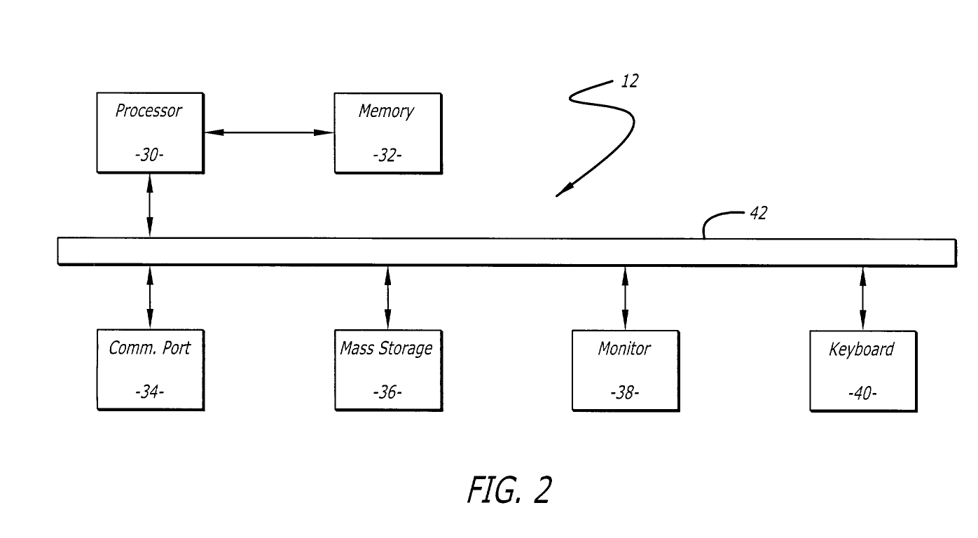

FIG. 2 shows an embodiment of a computer 12. The computer 12 includes a processor 30 connected to one or more memory devices 32. The memory device 32 may include both volatile and non-volatile memory such as read only memory (ROM) or random access memory (RAM). The processor 30 is capable of operating software programs in accordance with instructions and data stored within the memory device 32.

The processor 30 may be coupled to a communication port 34, a mass storage device 36, a monitor 38 and a keyboard 40 through a system bus 42. The communication port 34 may include an ETHERNET interface that allows data to be transmitted and received in TCP/IP format. The system bus 42 may be PCI or another conventional computer bus. The mass storage device 36 may include one or more disk drives such as magnetic or optical drives.

Without limiting the scope of the invention the term computer readable medium may include the memory device 32 and/or the mass storage device 36. The computer readable medium will contain software programs in binary form that can be read and interpreted by the computer. In addition to the memory device 32 and/or mass storage device 36, computer readable medium may also include a diskette, a compact disc, an integrated circuit, a cartridge, or even a remote communication of the software program. Although not shown, the server 16 may also have a processor, memory etc, as is known in the art.

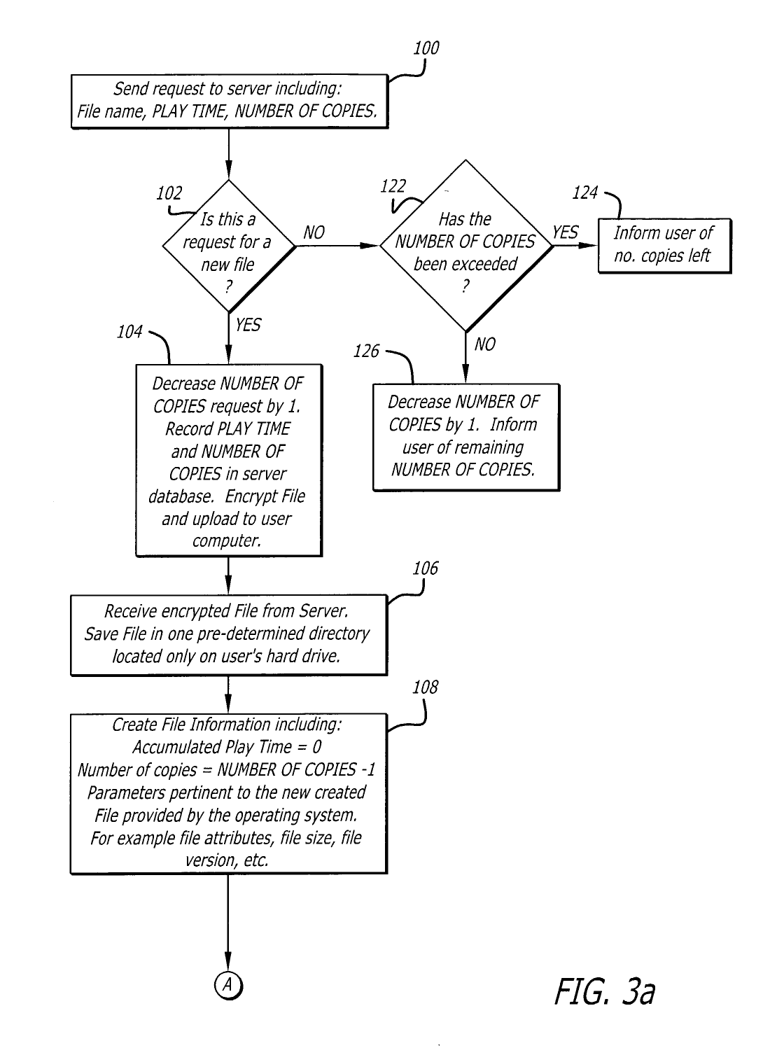

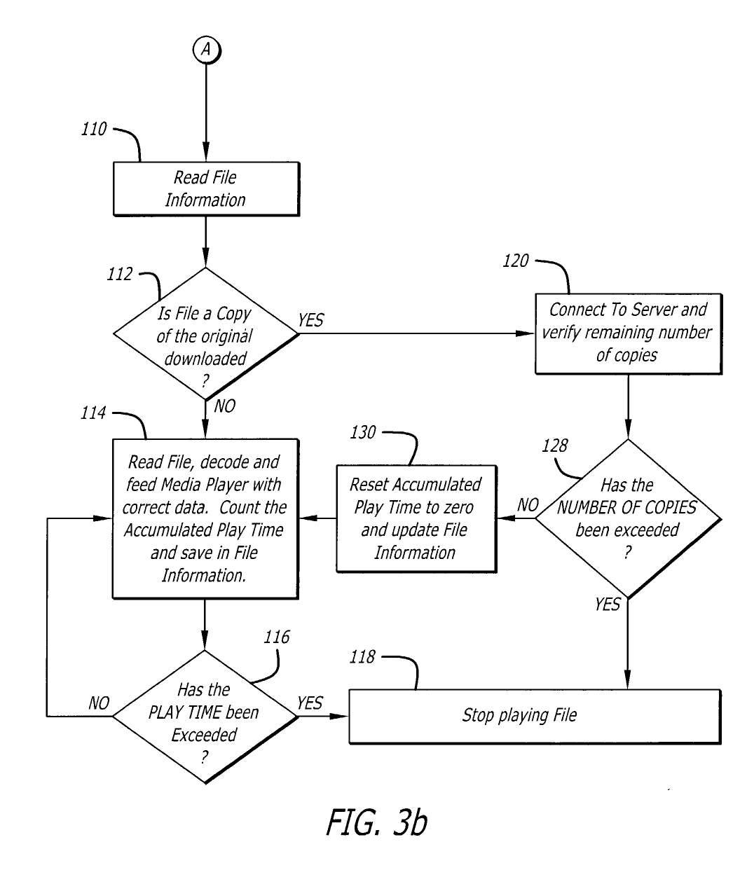

FIGS. 3a-3b show a flowchart of a method for downloading and playing a file transmitted through the network 14. In block 100 the user logs onto the server and request a file. The server may have a GUI that provides a number of prompts and field entries that allows the user to download a file. For example, the GUT may contain a number of fields that allow the user to enter the name of the media file (movie or song), a password and some type of transaction information such has a credit card number. Alternatively, the user may pre-purchase a certain number of files, or enter into any other type of arrangement to access the media files. The GUI will contain fields that allow the user to enter the play time and number of copies. The full play time of the file may be automatically prompted to provide a default selection for the user.

The server determines whether the request from the computer is for a new file in decision block 102. If the request is for a new file the server encrypts and transmits the file to the computer through the network in block 104. The server also logs the play time and number of copies in a database. The number of authorized copies is decremented by one to reflect the number of copies remaining after the file has been downloaded.

In block 106, the computer receives and stores the file in a pre-determined directory in the computer hard disk drive. The user computer may also receive a program(s) required to play the media file. The program may be stored on the hard disk drive. The program may also be read from a compact disk. The computer may also receive other programs required to play the video and/or audio data.

The computer logs the accumulated play time, authorized play time and number of authorized copies remaining in a directory database in step 108. The default value for the accumulated play time may be zero. The database may also contain other data such as file attributes, file size, file version, etc.

To play the file, the computer initially reads the file in step 110. The computer determines whether the file is a copy of the downloaded file in decision block 112. If it is not a copy, the computer decodes and plays the media file in block 114. The computer program also counts the time the media file is being played. In decision block 116, the computer program determines whether the counted play time exceeds the authorized play time. If the play time has not been exceeded the program continues to play the media file. If the play time has been exceeded the program stops playing the media file in block 118.

If the file is a copy, the computer program generates a request for the file that is transmitted to the server in block 120. The request is processed in block 102. Since this is not a request for a new file, the server proceeds to decision block 122 to determine whether the number of copies has been exceeded. If the number of copies has been exceed the server returns a message to the computer informing the user that the file cannot be played in block 124. If the number of copies has not be exceed, the server sends a command back to the computer in block 126. The server also decrements the number of copies value in the database by one.

In decision block 128, the computer determines whether the message from the server indicates that the number of copies has been exceeded. If the number of copies has been exceeded then the process continues to block 118 and the file is not played. If the number of copies is not exceeded the computer program resets the play time to zero in block 130. The process then continues to block 116.

Requiring the computer to communicate with the server to determine whether the number of copies is exceeded allows the provider to control how many times the file is played. This prevents unauthorized file swapping. Providing a play time allows the user to play portions of the file without having to reconnect with the server. Storing the file in the hard disk drive also minimizes the amount of time the computer is connected to the network and the server.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, when the computer program is loaded into a computer the program may self assign a computer identification code (ID) to the computer. Alternatively, the user may assign the ID code. When requesting a file from the server in block 100, the user may also enter the computer ID of the computer, or IDs if the file is to played in multiple computers. The server inserts the requested ID(s) into the file that is uploaded to the computer in block 104. The program then compares the ID(s) embedded into the file with the ID of the computer. If an ID matches, the program plays the file. If there is no match the program connects with the server in block 120. Assigning computer IDs allows the program to bypass the connection to the server even when the file is copied to another computer.

What is claimed is:

1. A method for playing a file that is transmitted through a network, comprising:
reading a file that has an authorized play time;
determining whether the authorized play time has been exceeded; and,
playing the file if the play time has not been exceeded.

2. The method of claim 1, wherein the file has an authorized number of copies, further comprising determining whether playing the file would exceed the authorized number of copies and playing the file if the authorized number of copies has not been exceeded.

3. The method of claim 2, further comprising transferring the file from a server to a computer.

4. The method of claim 3, wherein the file includes a computer identification code.

5. The method of claim 3, further comprising sending a request from the computer to the server to determine whether the number of authorized copies has been exceeded.

6. The method of claim 1, wherein the file includes video data.

7. The method of claim 1, wherein the file includes audio data.

8. The method of claim 3, further comprising storing the file on a hard disk drive of the computer.

9. The method of claim 3, wherein the file is transferred in TCP/IP format.

10. A system for playing a file transmitted through a network, comprising:
a network;
a server that transmits a file through said network, said file having an authorized play time; and,
a computer that receives the file and plays the file if the authorized play time has not been exceeded.

11. The system of claim 10, wherein the file has an authorized number of copies and the computer plays the file if the authorized number of copies has not been exceeded.

12. The system of claim 11, wherein said computer generates a request to said server to determine whether the number of authorized number of copies has been exceeded.

13. The system of claim 10, wherein the file includes a computer identification code.

14. The system of claim 10, wherein said computer contains a hard disk drive and the file is stored in said hard disk drive.

15. The system of claim 10, wherein the file contains video data.

16. The system of claim 10, wherein the file contains audio data.

17. A computer for playing a file that is transmitted through a network, comprising:
a memory device that stores a file that has a play time; and,
a processor that is coupled to said memory device, said processor reads the file, determines whether the play time has been exceeded and plays the file if the play time has not been exceeded.

18. The computer of claim 17, wherein the file includes an authorized number of copies and said processor plays the file if the authorized number of copies has not been exceeded.

19. The computer of claim 17, wherein said memory device includes a hard disk drive.

20. The computer of claim 18, wherein said processor generates an external request to determine whether the authorized number of files has been exceeded.

21. The computer of claim 17, wherein the file includes video data.

22. The computer of claim 17, wherein the file contains audio data.

23. The computer of claim 17, wherein the file includes a computer identification code.

24. A computer program storage medium that can cause a computer to play a file that is transmitted through a network, comprising:
a computer readable storage medium that contains a computer program which causes the computer to read a file that has a play time, determine whether the play time has been exceeded and plays the file if the play time has not been exceeded.

25. The storage medium of claim 24, wherein the file has an authorized number of copies and said computer program causes the computer to determine whether the authorized number of copies has been exceeded and plays the file if the authorized number of copies has not been exceeded.

26. The storage medium of claim 25, wherein the computer program causes the computer to generate an external request to determine whether the authorized number of copies is exceeded.

27. The storage medium of claim 24, wherein the computer program causes the computer to generate a computer identification code.

28. The storage medium of claim 24, wherein the file contains video data.

29. The storage medium of claim 24, wherein the file contains audio data.
